(19) United States
(12) Patent Application Publication
(10) Pub. No.: US 2019/0085887 A1
(43) Pub. Date: Mar. 21, 2019

(54) SPEEDY-SCREWING SCREW

(71) Applicant: TAIWAN SHAN YIN INTERNATIONAL CO., LTD., Kaohsiung City (TW)

(72) Inventors: KOU-TSAIR SU, KAOHSIUNG CITY (TW); YU-JUNG SU, KAOHSIUNG CITY (TW)

(21) Appl. No.: 16/059,388

(22) Filed: Aug. 9, 2018

(30) Foreign Application Priority Data
Sep. 21, 2017 (TW) 106214051

(51) Int. Cl. F16B 25/10; F16B 25/00

(52) U.S. Cl. CPC F16B 25/103; F16B 25/0015; F16B 25/0052; F16B 25/0068

(57) ABSTRACT

A speedy-screwing screw includes a shank, a head connected thereto, a drilling portion opposite to the head, a plurality of main threads and auxiliary threads disposed on the shank and extending in opposite directions. Each auxiliary thread has a plurality of cutting sections, each of which has two flank surfaces converging at a crest. Adjacent flank surfaces are continuously connected in reverse curves so that the crests are connected to be a wavy arrangement. During a screwing operation, the main threads execute a main cutting action, and concurrently the auxiliary threads push and then sever wood fibers effectively, thereby providing a dual cutting effect to prevent the shank and the drilling portion from being entangled in the wood fibers, reduce the screwing resistance caused by the entanglement of wood fibers, and speeding up the screwing operation.

### BACKGROUND OF THE INVENTION

### 1. Field of the Invention

This invention relates to a screw and relates particularly to a speedy-screwing screw.

### 2. Description of the Related Art

Referring to FIG. 1, a conventional screw 1 comprises a shank 11, a head 12 fitted on the shank 11, a tapered drilling portion 13 opposite to the head 12, and a plurality of threads 14 spirally fitted on the shank 11. During a screwing operation, the drilling portion 13 is situated at a surface of a wood board (not shown). The head 12 then receives a rotational force in order that the threads 14 is driven by the rotational force to cut the wood board. With the cutting action of the threads 14, the drilling portion 13 and the shank 11 further thread into the wood board gradually to complete the screwing operation of the screw 1.

However, the disclosed screw 1 still has problems. During the screwing operation, the screw 1 relies on the threads 14 to execute the cutting action of the wood board. However, the wood board is composed of a plurality of elastic wood fibers. The threads 14 are unable to serve the wood fibers effectively during the screwing operation. Meanwhile, instead of excluding outwards, the unserved wood fibers accumulate between the threads 14 unduly to further hinder the screwing operation. In addition, some unserved wood fibers entangle around the shank 11 and the drilling portion 13 to result in the increasing drilling resistance. Accordingly, the screwing operation of the screw 1 is not smooth and slowed down. Moreover, the entanglement of the wood fibers hinders debris incurred by the cutting action of the threads 14 from excluding outwards. Furthermore, the wood board may crack if the screw 1 keeps screwing downwards and pressing the accumulated debris. Thus, the screw 1 still needs to be improved.

### SUMMARY OF THE INVENTION

The object of this invention is to provide a speedy-screwing screw capable of serving wood fibers effectively to reduce the drilling resistance and attain a quick screwing effect.

The speedy-screwing screw of this invention comprises a shank, a head fitted at one end of the shank, a drilling portion fitted at another end of the shank and opposite to the head, a plurality of main threads spiraled on the shank, and a plurality of auxiliary threads extending in a second direction opposite to a first direction of the main threads. A main diameter of the main threads is larger than an auxiliary diameter of the auxiliary threads. Each auxiliary thread has a plurality of cutting sections. Each cutting section has two flank surfaces facing the head and the drilling portion respectively and a crest formed at a junction of the flank surfaces. Adjoining flank surfaces which face the same direction are connected continuously in reverse curves to form the wavelike crests. During a screwing operation, the main threads execute the main cutting action. Simultaneously, the auxiliary threads push and then break wood fibers of a wood object effectively, thereby providing a dual cutting effect to prevent the shank and the drilling portion from being entangled in wood fibers, and reduce the drilling resistance effectively. Moreover, debris can be excluded outwards through the main threads and the auxiliary threads, thereby preventing the debris from accumulating, preventing the wood object from cracking owing to the accumulated debris, and accelerating the screwing operation greatly.

Preferably, at least one of the main threads is provided with at least one slot.

Preferably, the auxiliary threads have continuous convolutions spiraling in the second direction.

Preferably, each auxiliary thread extends slantingly between two adjoining main threads.

### BRIEF DESCRIPTION OF THE DRAWINGS

FIG. 1 is a schematic view showing a conventional screw;

FIG. 2 is a schematic view showing a first preferred embodiment of this invention characterized by each auxiliary thread extends slantingly between main threads;

FIG. 2A is an enlarged view showing a partial element of FIG. 2;

FIG. 3 is a schematic view showing the auxiliary threads are formed in continuous convolutions.

FIG. 4 is a schematic view showing a screwing operation of the first preferred embodiment of this invention;

FIG. 5 is a schematic view showing a second preferred embodiment of this invention characterized by a plurality of slots formed on the main threads; and

FIG. 6 is a schematic view showing a plurality of slots formed on the main threads and the auxiliary threads formed in connective convolutions.

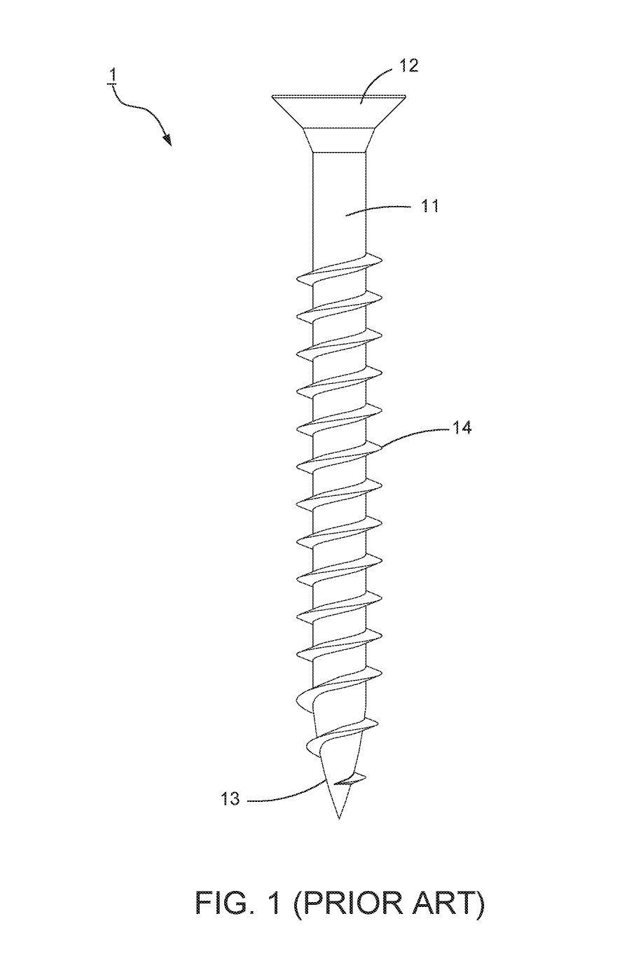

### DETAILED DESCRIPTION OF THE PREFERRED EMBODIMENTS

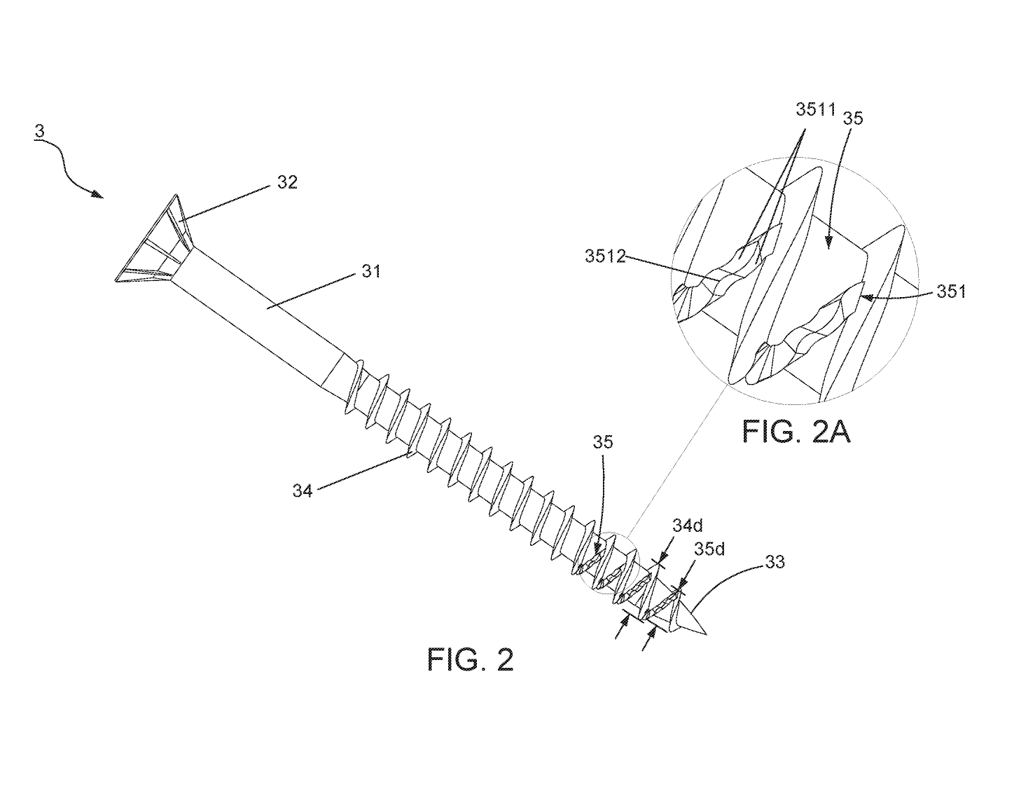

Referring to FIG. 2, a first preferred embodiment of a speedy-screwing screw 3 of this invention is disclosed. The speedy-screwing screw 3 includes a shank 31, a head 32 connected to one side of the shank 31, a drilling portion 33 formed at another side of the shank 31 and opposite to the head 32, a plurality of main threads 34 spirally disposed on the shank 31, and a plurality of auxiliary threads 35 formed on the shank 31 between the main threads 34 and extending toward the drilling portion 33. The main threads 34 spirally extend in a first direction. The auxiliary threads 35 spirally extend in a second direction which is reverse to the first direction of the main threads 34. In this preferred embodiment, the main threads 34 are right hand threads. On the contrary, the auxiliary threads 35 are left hand threads. Further, it is preferable that the auxiliary threads 35 are disposed between the main threads 34 and particularly the auxiliary threads 35 alternate with part of the main threads 34, as shown in the figures. A main diameter 34d of the main threads 34 is larger than an auxiliary diameter 35d of the auxiliary threads 35. In addition, referring to FIG. 2, each of the auxiliary threads 35 may extend slantingly between two adjacent main threads 34 so that the auxiliary threads 35 disconnect from each other.

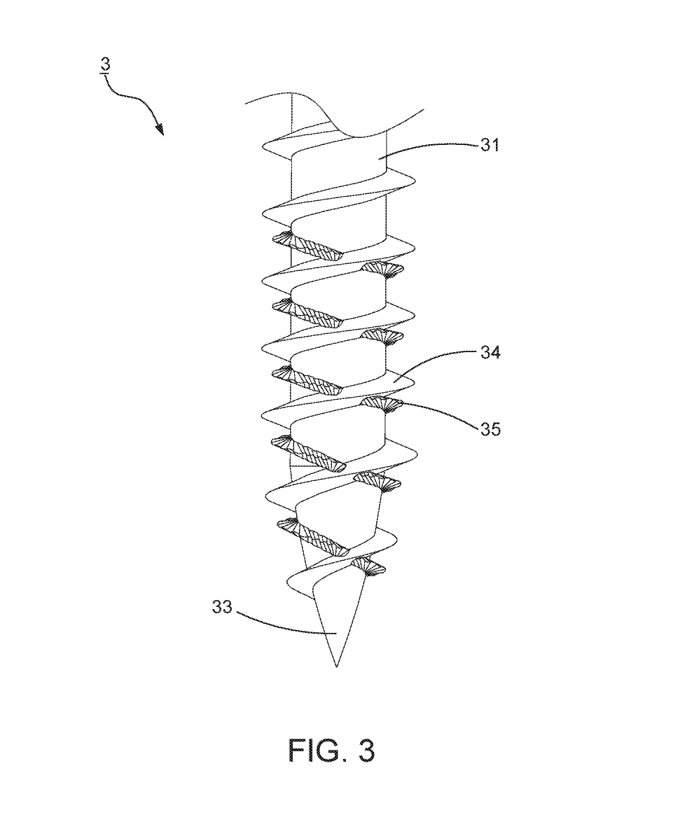

Alternatively, the auxiliary threads 35 have continuous convolutions spiraling in the second direction. In other words, the auxiliary threads 35 can be formed in connective convolutions, as shown in FIG. 3. Further, the extension length of the auxiliary threads 35 can be adjusted according to needs. Here takes an example that the auxiliary threads 35 slantingly extend to the drilling portion 33. Referring to FIG. 2A, each auxiliary thread 35 includes a plurality of cutting sections 351 connected one after another. Each cutting section 351 has two flank surfaces 3511 facing the head 32 and the drilling portion 33 respectively and a crest 3512 formed at a convergence of the two flank surfaces 3511. Neighboring flank surfaces 3511 which face the same direction are continuously connected in reverse curves. In other words, one flank surface 3511 is an upward curve in the middle, and another flank surface 3511 adjoining the one flank surface 3511 is a concave curve in the middle to allow the connected crests 3512 to lie like waves rising and falling.

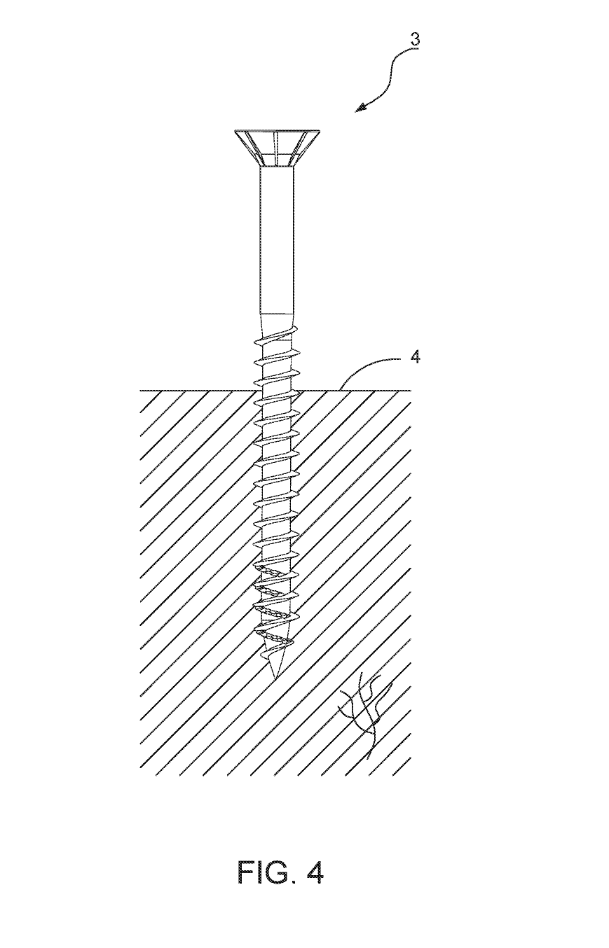

Referring to FIG. 2 and FIG. 4, a screwing operation of the speedy-screwing screw 3 begins with positioning the drilling portion 33 against a surface of a wood object 4. Then, the head 32 receives a rotation force from a driving tool (not shown) in order to carry out the drilling action of the drilling portion 33 and synchronously rotate the main threads 34 to execute the main cutting action of the wood object 4. Meanwhile, the auxiliary threads 35 is also driven by the rotation force to assist the drilling portion 33 in reaming the wood object 4 and help the main threads 34 push and then break wood fibers of the wood object 4 effectively, thereby preventing the shank 31 and the drilling portion 33 from being entangled in the wood fibers, reducing the drilling resistance caused by the entanglement of wood fibers. Moreover, when the speedy-screwing screw 3 gradually screws into the wood object 4, debris incurred during the cutting action can be excluded outwards through the main threads 34 and the auxiliary threads 35, thereby increasing the smoothness of excluding debris. Thus, the cooperation between the main threads 34 and the auxiliary threads 35 allows the speedy-screwing screw 3 to serve the wood fibers effectively. The main threads 34 execute the main cutting action of the wood object 4, and concurrently the auxiliary threads 35 push and then sever the wood fibers, thereby providing a dual cutting effect to avoid the entanglement of the wood fibers around the shank 31 and the drilling portion 33, decreasing the drilling resistance incurred during the screwing operation, preventing the wood object 4 from cracking caused by continuously pressing the unduly accumulated debris, and attaining a quick screwing effect.

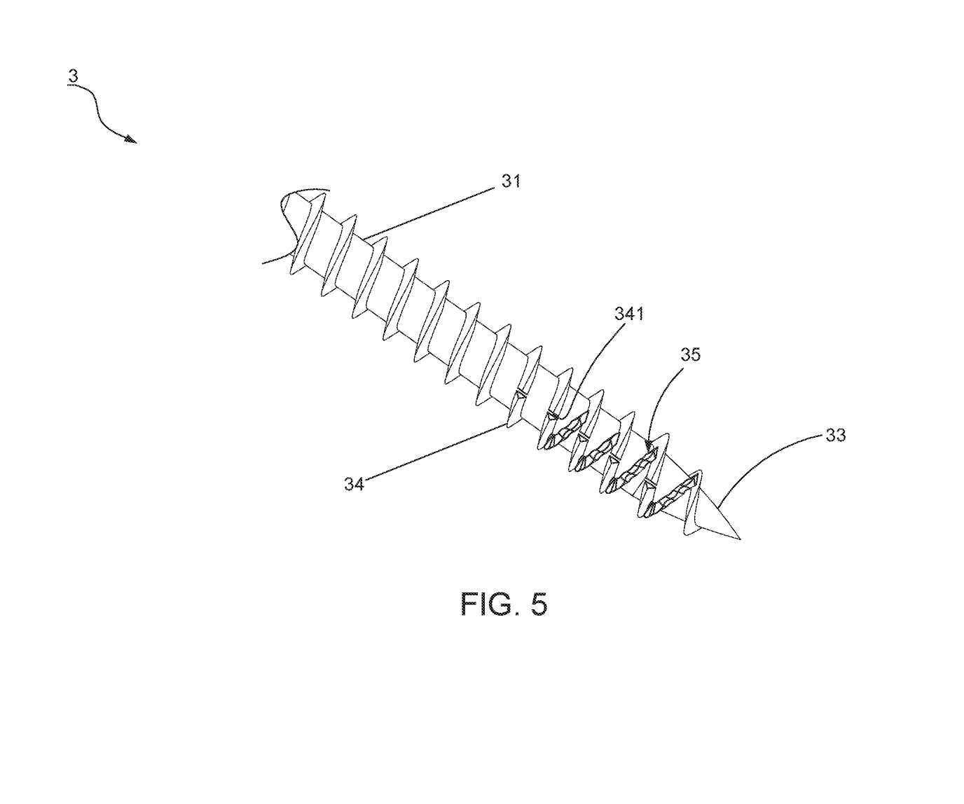

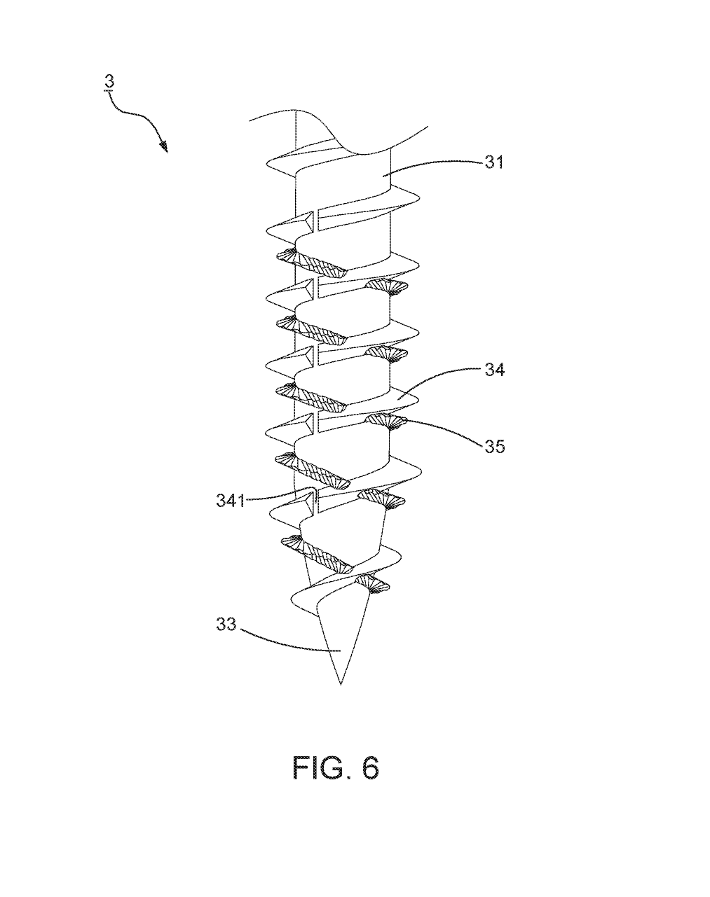

Referring to FIG. 5 shows a second preferred embodiment of the speedy-screwing screw 3 of this invention. The correlated elements and the concatenation of elements, the operation and objectives of the second preferred embodiment are the same as those of the first preferred embodiment. This embodiment is characterized in that at least one of the main threads 34 is provided with at least one slot 341 which allows the debris incurred during the cutting action to be excluded through the slot 341 smoothly. Referring to FIG. 6, the slot 341 may be formed on the main threads 34 while the auxiliary threads 35 are formed in continuous convolutions. Hence, the debris can be excluded through not only the main threads 34 and the auxiliary threads 35, but also the slot 341, thereby increasing the smoothness of excluding debris, preventing the wood object 4 (not shown) from cracking caused by pressing the accumulated debris, speeding up the screwing operation greatly, and achieving the quick screwing effect. To sum up, the speedy-screwing screw of this invention takes an advantage of the wavelike auxiliary threads which extend in the direction reverse to the direction of the main threads to push and then serve the wood fibers effectively, thereby attaining the dual cutting effect to prevent the drilling portion and the shank from being entangled in the wood fibers, reduce the drilling resistance, accelerate the screwing operation greatly, and achieve the quick screwing effect.

While the embodiments of this invention are shown and described, it is understood that further variations and modifications may be made without departing from the scope of this invention.

What is claimed is:

1. A speedy-screwing screw comprising a shank, a head disposed at one end of said shank, a drilling portion disposed at another end of said shank and opposite to said head, and a plurality of main threads spirally formed on said shank and having main thread convolutions spiraling in a first direction;
wherein a plurality of auxiliary threads are disposed on said shank between said main threads and extend in the direction of said drilling portion, said plurality of auxiliary threads extending in a second direction which is reverse to said first direction of said plurality of main threads, a main diameter of said plurality of main threads being larger than an auxiliary diameter of said plurality of auxiliary threads, each of said auxiliary threads including a plurality of cutting sections which are connected one after another, each of said cutting sections including two flank surfaces facing said head and said drilling portion respectively and a crest formed at a junction of said two flank surfaces, adjacent flank surfaces which face a same direction being continuously connected in reverse curves to allow said plurality of crests to lie like waves rising and falling.

2. The speedy-screwing screw as claimed in claim 1, wherein at least one of said main threads is provided with at least one slot.

3. The speedy-screwing screw as claimed in claim 1, wherein said auxiliary threads have continuous convolutions spiraling in the second direction.

4. The speedy-screwing screw as claimed in claim 2, wherein said auxiliary threads have continuous convolutions spiraling in the second direction.

5. The speedy-screwing screw as claimed in claim 1, wherein said auxiliary threads each extends slantingly between two adjacent main threads.

6. The speedy-screwing screw as claimed in claim 2, wherein said auxiliary threads each extends slantingly between two adjacent main threads.
